(19) United States
(12) Patent Application Publication
(10) Pub. No.: US 2017/0287380 A1
(43) Pub. Date: Oct. 5, 2017

(54) COF STRUCTURE, DRIVING CIRCUIT AND DISPLAY DEVICE

(71) Applicant: SHENZHEN CHINA STAR OPTOELECTRONICS TECHNOLOGY CO., LTD., Shenzhen (CN)

(72) Inventor: Feng ZHAO, Shenzhen (CN)

(21) Appl. No.: 15/119,130

(22) PCT Filed: Apr. 22, 2016
(86) PCT No.: PCT/CN2016/080034

§ 371 Date: Aug. 16, 2016

(30) Foreign Application Priority Data
Apr. 5, 2016 (CN) 201610204869.7

(51) Int. Cl. G09G 3/20

(52) U.S. Cl. CPC G09G 3/2092; G09G 2300/04

(57) ABSTRACT

The present invention provides a COF structure, which comprises a thin-film body, two or more driving chip, bonding wires, and bonding marks. The two or more driving chips are disposed on the same thin-film body, to generate driving signals. The bonding wires are disposed on a top side or a bottom side of the thin-film body, to form a bonding connection between external signal lines and wires of the driving chips The bonding marks are disposed laterally on the thin-film body, to perform a location operation on the thin-film body which is used for a bonding operation.

### BACKGROUND OF THE INVENTION

### Field of Invention

The present invention relates to the field of displays, and more particularly to a chip on film (COF) structure, a driving circuit, and a display device.

### Description of Prior Art

With technological development, users desire more and more from the display panel design. Generally, a chip on film (COF) structure is used to drive the conventional display panel.

Please kindly refer to FIG. 1 and FIG. 2. FIG. 1 is a structural illustrative drawing of a conventional COF structure, and FIG. 2 shows an arrangement of multiple conventional COF structures. Conventionally, a COF structure 10 generally comprises a driving chip 11, bonding wires 12, and a bonding mark 13. The bonding wires 12 are used to connect with exterior data lines, and the bonding mark 13 is used to locate on the COF structure.

On the same COF structure 10, a certain distance should be reserved between the bonding wires 12 and the bonding mark 13, and a certain distance should be reserved between the bonding mark 13 and edges of the COF structure 10, in order to ensure the working stability of the COF. Meanwhile, a safe distance should be reserved between adjacent COF structures 10, to prevent mutual interference among the adjacent COF structures.

However, in the conventional art, intervals between the adjacent COF structures 10 are too large to be suitable for the requirement of a display panel with a high resolution rate and a driving chip with small intervals.

Hence, it is necessary to provide a COF structure, a driving circuit, and a display device, to solve the above technical issues.

### SUMMARY OF THE INVENTION

An objective of the present invention is to provide a COF structure, a driving circuit, and a display device which are suitable for the requirement of a display panel with a high resolution rate and a driving chip with small intervals, with the basis of keeping larger intervals between adjacent COFs. The present invention solves the technical issues regarding a longer interval between two adjacent COF structures, which is not suitable for a high resolution display panel in need of smaller intervals between adjacent driving chips.

The embodiment of the present invention provides a COF structure, which comprises:

a thin-film body; two or more driving chips are disposed on the same thin-film body, to generate driving signals; bonding wires are disposed on a top side or a bottom side of the thin-film body, to form a bonding connection between external signal lines and wires of the driving chips; and bonding marks are disposed laterally on the thin-film body, to perform a location operation on the thin-film body which is used for a bonding operation.

In the preferred embodiment, a distance between the two driving chips of the same thin-film body is less than a distance between the adjacent COF structures.

In the preferred embodiment, quantities of the bonding wires corresponding to the two driving chips of the same thin-film body are the same.

In the preferred embodiment, quantities of the bonding wires corresponding to the two driving chips of the same thin-film body are different.

In the preferred embodiment, the bonding mark is disposed on a left side of the thin-film body.

In the preferred embodiment, the bonding mark is disposed on a right side of the thin-film body.

In the preferred embodiment, the bonding mark is disposed on a left side and a right side of the thin-film body.

The embodiment of the present invention provides a driving circuit for driving a display panel, which comprises a COF structure. The COF structure comprises:

a thin-film body; two or more driving chips disposed on the same thin-film body, to generate driving signals; bonding wires disposed on a top side or a bottom side of the thin-film body, to form a bonding connection between external signal lines and wires of the driving chips; and bonding marks disposed laterally on the thin-film body, to perform a location operation on the thin-film body which is used for a bonding operation.

In the preferred embodiment, a distance between the two driving chips of the same thin-film body is less than a distance between the adjacent COF structures.

In the preferred embodiment, quantities of the bonding wires corresponding to the two driving chips of the same thin-film body are the same.

In the preferred embodiment, quantities of the bonding wires corresponding to the two driving chips of the same thin-film body are different.

In the preferred embodiment, the bonding mark is disposed on a left side of the thin-film body.

In the preferred embodiment, the bonding mark is disposed on a right side of the thin-film body.

In the preferred embodiment, the bonding mark is disposed on a left side and a right side of the thin-film body.

The embodiment of the present invention provides a display device, which comprises a display panel and a driving circuit with a COF structure. The COF structure comprises:

a thin-film body; two or more driving chips are disposed on the same thin-film body, to generate driving signals; bonding wires are disposed on a top side or a bottom side of the thin-film body, to form a bonding connection between external signal lines and wires of the driving chips; and bonding marks are disposed laterally on the thin-film body, to perform a location operation on the thin-film body which is used for a bonding operation.

In the preferred embodiment, quantities of the bonding wires corresponding to the two driving chips of the same thin-film body are the same.

In the preferred embodiment, quantities of the bonding wires corresponding to the two driving chips of the same thin-film body are different.

In the preferred embodiment, the bonding mark is disposed on a left side and/or a right side of the thin-film body.

In the preferred embodiment, the display panel is a curve display panel.

Compared with the conventional art, the COF structure, the driving circuit, and the display device of the present invention, with the basis of keeping larger intervals between adjacent COFs, is suitable for the requirement of a high resolution display panel in need of a narrow interval between adjacent driving chips. The present invention solves the technical issues regarding a longer interval between two adjacent COF structures, which is not suitable for a high resolution display panel in need of a narrow interval between adjacent driving chips.

To make the above-described present invention more fully comprehensible, with preferred embodiments accompanied with drawings, the detail descriptions are as below.

### BRIEF DESCRIPTION OF THE DRAWINGS

FIG. 1 is a structural illustrative drawing of a COF structure of the conventional art;

FIG. 2 shows an arrangement of multiple conventional COF structures;

FIG. 3 is a structural illustrative drawing of a COF structure of a preferred embodiment of the present invention; and

FIG. 4 is a line up structural illustrative drawing of multiple COF structures of the present invention.

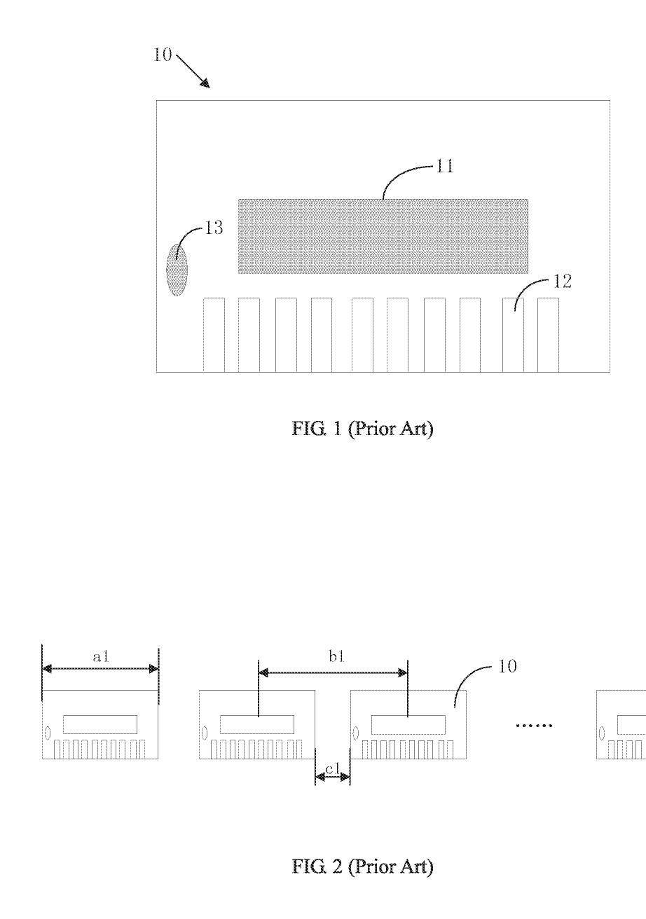

### DETAILED DESCRIPTION OF THE PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention.

In the drawings, components having similar structures are denoted by the same numerals.

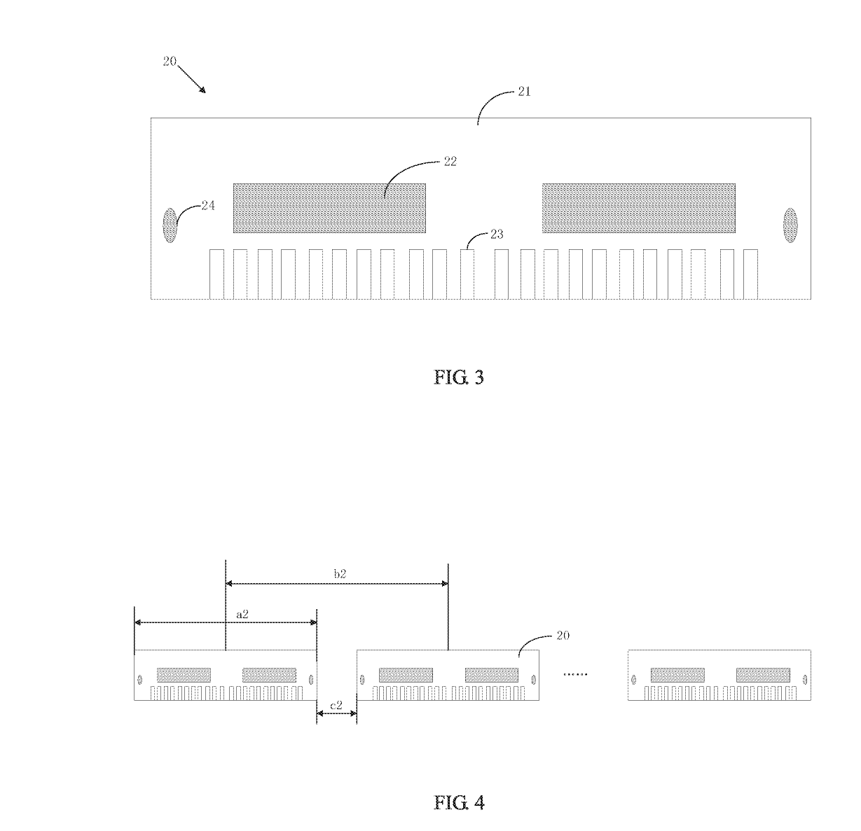

Please refer to FIG. 3 and FIG. 4. FIG. 3 is a structural illustrative drawing of a COF structure of a preferred embodiment of the present invention, and FIG. 4 shows an arrangement of multiple COF structures of the present invention. According the preferred embodiment, a COF structure 20 comprises a thin-film body 21, two or more driving chips 22, bonding wires 23, and bonding marks 24.

The two or more driving chips 22 are disposed on the same thin-film body 21, to generate driving signals. The bonding wires 23 are disposed on a top side or a bottom side of the thin-film body 21, to form a bonding connection between external signal lines and wires of the driving chips 22. The bonding marks 24 are disposed laterally on the thin-film body 21, to perform a location operation on the thin-film body 21 which is used for bonding operation.

As FIG. 4 shows, a distance between the two driving chips 22 of the same thin-film body 21 is less than a distance between the adjacent COF structures 20. Hence, more driving chips 22 can be disposed in the same area.

In the COF structure 20 of the preferred embodiment, quantities of the bonding wires 23 corresponding to the two driving chips 22 of the same thin-film body 21 can be the same or different. Specifically, it is setup according to the user's requirements.

In the COF structure 20 of the preferred embodiment, the bonding marks 24 can be disposed on a left side and a right side of the thin-film body 21, to facilitate a bonding operation with external signal lines.

When using the COF structure 20 of the preferred embodiment, the position operation of the thin-film body 21 of the COF structure 20 is performed by the bonding marks 24, then the bonding operation is directly performed by using the external signal lines and the bonding wires 23, to realize the connection between the external signal lines and the wires of the driving chips 22.

Please refer to FIG. 2 and FIG. 4. In the conventional COF structure 10 of FIG. 2, a length al of the COF structure 10 is 42,000 μm, a distance b1 between adjacent COF structures 10 is 51,040 μm, a distance c1 between edges of adjacent COF structures 10 is 9,040 μm. In other words, the distance between edges of adjacent COF structures 10 is smaller.

However, in COF structure 20 of FIG. 4 of the preferred embodiment, a length a2 of the COF structure 20 is 63,660 μm, a distance b2 between adjacent COF structures 20 is 102,080 μm, and a distance c2 between edges of adjacent COF structures 20 is 38,420 μm. In the situation that the distance b2 of adjacent COF structures which correspond to per quantity of the driving chips 22 is the same, the distance c2 between edges of the adjacent COF structures 20 is much larger than the distance c1 between edges of the adjacent COF structures 10. If setting the COF structure 20 of the preferred embodiment by 9,040 μm (a safe distance), more COF structures 20 can be disposed in the same area or length. Hence, the COF structure 20 of the present preferred embodiment has better stability and can be better suitable for the requirement of a display panel with a high resolution rate and a driving chip with small intervals.

Because the COF structure of the preferred embodiment disposed two or more driving chips in the thin-film body, with the basis of keeping larger intervals between adjacent COFs, it is suitable for the requirement of a display panel with a high resolution rate and a driving chip with small intervals.

The present invention further provides a driving circuit with a COF structure for driving a display panel. The COF structure comprises a thin-film body, bonding wires, and bonding marks.

The two or more driving chips are disposed on the same thin-film body, and are used to generate driving signals. The bonding wires are disposed on a top side or a bottom side of the thin-film body, to form a bonding connection between external signal lines and wires of the driving chips. The bonding marks disposed laterally on the thin-film body, are used to locate on the thin-film body which is used for a bonding operation.

Preferably, a distance between the two driving chips of the same thin-film body is less than a distance between the adjacent COF structures.

Preferably, quantities of the bonding wires corresponding to the two driving chips of the same thin-film body are the same or different.

Preferably, the bonding mark is disposed on a left side and a right side of the thin-film body.

The specific working theory of the driving circuit of the present invention is the same or similar to COF structure of the preferred embodiment, please refer to the relative description of the COF structure of the preferred embodiment.

The present invention further provides a display device, which comprises a display panel and a driving circuit, wherein the driving circuit comprises a COF structure, which comprises a thin-film body, bonding wires, and bonding marks.

The two or more driving chips are disposed on the same thin-film body, to generate driving signals; the bonding wires are disposed on a top side or a bottom side of the thin-film body, to form a bonding connection between external signal lines and wires of the driving chips; the bonding marks are disposed laterally on the thin-film body, to perform a location operation on the thin-film body which is used for a bonding operation.

The specifically working theory of the display device of the present invention is the same or similar to the COF structure of the preferred embodiment, please refer to the relative description of the COF structure of the preferred embodiment.

Preferably, the display panel is a curved display panel. The display device of the present invention uses less COF structures at the same resolution rate, with the larger intervals between the adjacent COF structures. Such display device is able to solve the technical problem of damaging the COF structure resulting from a narrow interval between the adjacent COF structures, and greatly raises the yield rate of the display device.

The COF structure, the driving circuit, and the display device of the present invention, with the basis of keeping larger intervals between adjacent COFs, is for suitable for the requirement of a high resolution display panel in need of a narrow interval between adjacent driving chips. The present invention solves the technical issues regarding a longer interval between two adjacent COF structures, which is not suitable for a high resolution display panel in need of a narrow interval between adjacent driving chips.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

What is claimed is:

1. A chip on film (COF) structure, comprising:
a thin-film body;
two or more driving chips, disposed on the same thin-film body, to generate driving signals;
bonding wires, disposed on a top side or a bottom side of the thin-film body, to form a bonding connection between external signal lines and wires of the driving chips; and
bonding marks, disposed laterally on the thin-film body, to perform a location operation on the thin-film body which is used for a bonding operation.

2. The COF structure according to claim 1, wherein a distance between the two driving chips of the same thin-film body is less than a distance between the adjacent COF structures.

3. The COF structure according to claim 1, wherein quantities of the bonding wires corresponding to the two driving chips of the same thin-film body are the same.

4. The COF structure according to claim 1, wherein quantities of the bonding wires corresponding to the two driving chips of the same thin-film body are different.

5. The COF structure according to claim 1, wherein the bonding mark is disposed on a left side of the thin-film body.

6. The COF structure according to claim 1, wherein the bonding mark is disposed on a right side of the thin-film body.

7. The COF structure according to claim 1, wherein the bonding mark is disposed on a left side and a right side of the thin-film body.

8. A driving circuit, used to drive a display panel, which comprises a COF structure, the COF structure comprising:
a thin-film body;
two or more driving chips, disposed on the same thin-film body, to generate driving signals;
bonding wires, disposed on a top side or a bottom side of the thin-film body, to form a bonding connection between external signal lines and wires of the driving chips; and
bonding marks, disposed laterally on the thin-film body, to perform a location operation on the thin-film body which is used for a bonding operation.

9. The driving circuit according to claim 8, wherein a distance between the two driving chips of the same thin-film body is less than a distance between the adjacent COF structures.

10. The driving circuit according to claim 8, wherein quantities of the bonding wires corresponding to the two driving chips of the same thin-film body are the same.

11. The driving circuit according to claim 8, wherein quantities of the bonding wires corresponding to the two driving chips of the same thin-film body are different.

12. The driving circuit according to claim 8, wherein the bonding mark is disposed on a left side of the thin-film body.

13. The driving circuit according to claim 8, wherein the bonding mark is disposed on a right side of the thin-film body.

14. The driving circuit according to claim 8, wherein the bonding mark is disposed on a left side and a right side of the thin-film body.

15. A display device, comprising a display panel and a driving circuit with a COF structure, the COF structure comprising:
a thin-film body;
two or more driving chips, disposed on the same thin-film body, to generate driving signals;
bonding wires, disposed on a top side or a bottom side of the thin-film body, to form a bonding connection between external signal lines and wires of the driving chips; and
bonding marks, disposed laterally on the thin-film body, to perform a location operation on the thin-film body which is used for a bonding operation.

16. The display device according to claim 15, wherein quantities of the bonding wires corresponding to the two driving chips of the same thin-film body are the same.

17. The display device according to claim 15, wherein quantities of the bonding wires corresponding to the two driving chips of the same thin-film body are different.

18. The display device according to claim 15, wherein the bonding mark is disposed on a left side and/or a right side of the thin-film body.

19. The display device according to claim 15, wherein the display panel is a curved display panel.
